(19) United States
(12) Patent Application Publication
(10) Pub. No.: US 2014/0302354 A1
(43) Pub. Date: Oct. 9, 2014

(54) Electrodes for Magnesium Energy Storage Devices

(71) Applicant: Battelle Memorial Institute, Richland, WA (US)

(72) Inventors: Yuyan Shao, Richland, WA (US); Jun Liu, Richland, WA (US)

(73) Assignee: BATTELLE MEMORIAL INSTITUTE, Richland, WA (US)

(21) Appl. No.: 13/947,914

(22) Filed: Jul. 22, 2013

Related U.S. Application Data
(63) Continuation-in-part of application No. 13/858,764, filed on Apr. 8, 2013.

(51) Int. Cl. H01M 4/46

(52) U.S. Cl. CPC H01M 4/466
USPC 429/50; 429/188

(57) ABSTRACT

Nanostructured bismuth materials can be utilized as an insertion material in electrodes for magnesium energy storage devices to take advantage of short diffusion lengths for Mg²⁺. The result can be a significantly increased charge/discharge rates and/or improved cycling stabilities. In one example, an energy storage device has magnesium as an electroactive species, an electrolyte salt containing magnesium, and an anode having bismuth nanostructures. The bismuth nanostructures have at least one dimension that is less than or equal to 25 nm. At least a portion of the magnesium is reversibly inserted into, and extracted from, the anode during discharging and charging states, respectively.

### CROSS-REFERENCE TO RELATED APPLICATIONS

This invention claims priority from, and is a continuation in part of, currently pending U.S. patent application Ser. No. 13/858,764, filed Apr. 8, 2013, which is incorporated herein by reference.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

Multivalent energy storage systems can offer good alternatives to lithium and sodium systems. One example of a multivalent energy storage system includes magnesium-based energy storage systems. However, unlike lithium and sodium batteries, common magnesium electrolyte compositions are not compatible with magnesium metal anodes. Examples of common magnesium electrolyte compositions can include, but are not limited to, Mg(ClO₄)₂, Mg(TFSI)₂, etc. in a nonaqueous solvent comprising PC, acetonitrile, etc. The incompatibility between electrolyte and anode is due to the inability to conduct Mg²⁺ ions through the solid electrolyte interphase (SEI) layer formed on the surfaces of the magnesium anode. Therefore, alternative anodes that are compatible with common magnesium electrolytes are applicable and useful for magnesium-based energy storage.

### SUMMARY

Bismuth is one alternative anode material since it can form an alloy with magnesium. However, bismuth anodes can be characterized by slow Mg²⁺ diffusion kinetics in the MgBiₓ alloy. Embodiments of the present invention employ nanostructured bismuth materials as an insertion material to take advantage of short diffusion lengths for Mg²⁺. The result of using the Bi nanostructured insertion materials of the present invention as anodes in magnesium energy storage systems can be a significantly increased charge/discharge rate and/or an improved cycling stability.

In one embodiment, an energy storage device has an electroactive species comprising magnesium, an electrolyte salt comprising magnesium, and an anode comprising bismuth nanostructures. The bismuth nanostructures have at least one dimension that is less than or equal to 25 nm. At least a portion of the magnesium is reversibly inserted into, and extracted from, the anode during discharging and charging processes, respectively. Preferably, the energy storage device has an anode specific capacity greater than 260 mAh/g based on complete anode weight.

The bismuth nanostructures can comprise bismuth nanotubes. Alternatively, the bismuth nanostructures can comprise nanoparticles, nanowires, nanorods, nanoplates or combinations thereof. In preferred embodiments, bismuth nanotubes, nanowires, and/or nanorods have an average diameter less than or equal to 15 nm.

In some instances, the anode comprises a composite having bismuth nanostructures and an electrically conductive material. One examples of an electrically conductive material includes, but is not limited to, one or more forms of electrically conductive carbon.

In one embodiment, the energy storage device can further have a cathode comprising transition metal oxides, transition metal sulfides, or conjugated polymers. Examples of oxides can include, but are not limited to MnO₂ and V₂O₅. Examples of sulfides can include, but are not limited to, Mo₆S₈ and TiS₂. Examples of polymers can include, but are not limited to, polypyrrole, (poly)quinones, polyimides, and organic materials that contain C═O/C═O—O bonds, R—S—R bonds, and R—X(O)—R bonds. R can represent alkyl groups or aromatic groups and X can represent nitrogen or phosphorous. A separator or membrane can separate the anode and the cathode. Known separators available for lithium ion batteries can be suitable for embodiments described herein. One example of a separator includes, but is not limited to, a glass fiber separator.

The magnesium anodes described herein can be fabricated according to the methods described herein for preparing an electrode. According to one embodiment, a method comprises the steps of configuring an electrochemical cell having an anode comprising magnesium metal, a cathode comprising bismuth nanostructures, and an electrolyte solution comprising a magnesium salt. The bismuth nanostructures have at least one dimension that is less than or equal to 25 nm. The embodiment then involves electrochemically stripping magnesium from the anode and inserting magnesium into the cathode, thereby yielding an insertion-material electrode comprising MgₓBi_{y}.

The MgₓBi_{y} insertion-material electrode can be utilized as the negative electrode in a magnesium energy storage device during a charged state as described elsewhere herein. In a preferred embodiment, the magnesium energy storage device has a positive electrode comprising Mo₆S₈ during a charged state.

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 includes schematic diagrams depicting a cell configuration for preparing an electrode comprising Bi nanostructures (1A) and a magnesium energy storage device having an anode comprising Bi nanostructures (1B), both according to aspects of the present invention.

FIG. 2 is a graph of voltage as a function of capacity comparing a traditional magnesium cell with a magnesium energy storage device according to embodiments of the present invention.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

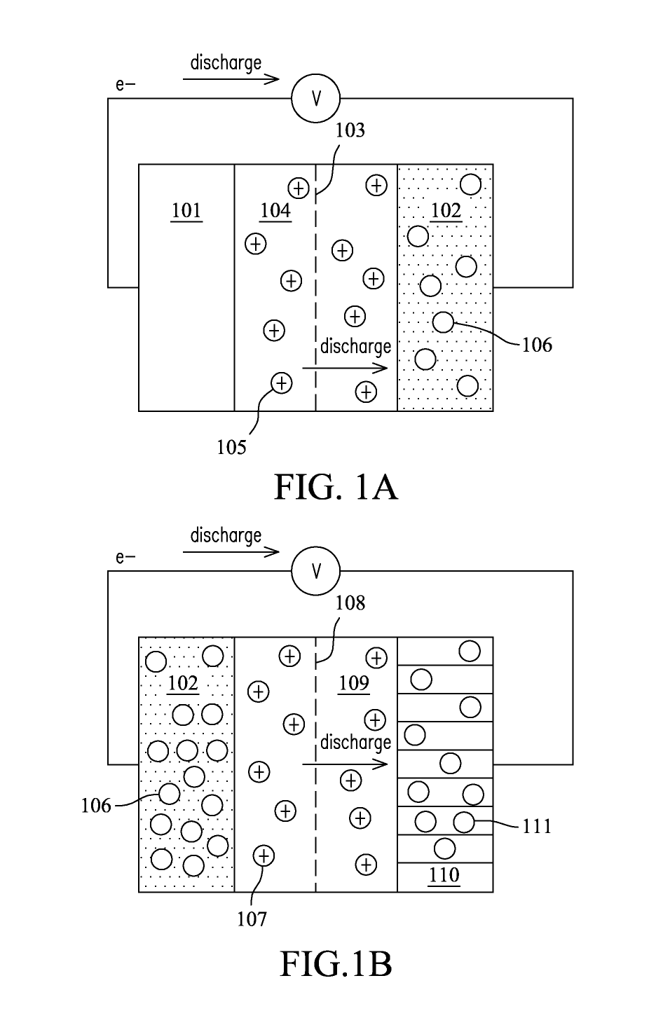

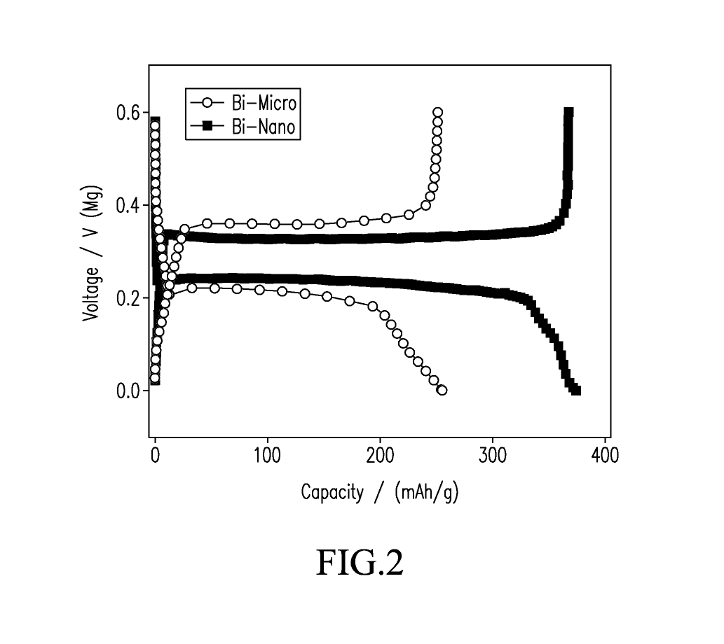

FIGS. 1-2 show a variety of aspects and embodiments of the present invention. Referring first to FIG. 1, schematic diagrams depict an electrochemical cell used to prepare an MgₓBi_{y} nanostructured insertion-material electrode (FIG. 1A) and a magnesium energy storage device utilizing the MgₓBi_{y} nanostructured insertion-material electrode as an anode (FIG. 1B).

In FIG. 1A, Mg²⁺ ions 105 are extracted from a magnesium metal anode 101 into an electrolyte 104 comprising magnesium during a discharge state. The Mg²⁺ ions pass through a separator 103 to a cathode that comprises bismuth nanostructures. The Mg²⁺ ions are intercalated 106 into the cathode to form a MgₓBi_{y} nanostructured insertion-material electrode 102.

The bismuth nanostructure material was synthesized according to the protocol described by Li et al. in J. Am Chem. Soc. 2001, 123 9904-9905. Briefly, analytically pure bismuth nitrate [Bi(NO₃)₃, 0.01 mol] and an excess amount of aqueous hydrazine solution (N₂H₄*H₂O, 0.02 mol) were put in distilled water at room temperature to form a mixture with insoluble precipitate. The pH value of the resulting solution was adjusted to the range of 12-12.5 by addition of aqueous NH₃*H₂O. The mixture was stirred strongly for about 0.5 h and then transferred into a Teflon-lined stainless steel autoclave. The autoclave was sealed and maintained at 120° C. for 12 h. After the reaction was completed, the resulting black solid product was filtered, washed with diluted hydrochloric acid (1 M) for several times to remove bismuth oxide or hydroxide possibly remnant in the final products and then saturated NaBH₄ solution to avoid oxidation of the product, and finally dried in a vacuum at 60° C. for 4 h.

In one example, the nanotubes had an average diameter of approximately 5 nm and lengths ranging from approximately 100 nm to 10 μm. In another example, bismuth nanoparticles can have an average diameter less than 20 nm. The nanoparticles might agglomerate, but agglomeration does not appear to negatively affect performance. Other sizes can be synthesized and are suitable for embodiments of the present invention.

In some embodiments, the bismuth nanostructure material can be mixed with an electrically conductive material to yield a composite. In one example, the electrically conductive material comprises carbon. A Bi nanostructure material and carbon composite can be formed into an ink, which is then coated onto a copper foil to form an electrode.

In FIG. 1B, an MgₓBi_{y} nanostructured insertion-material electrode 102 is arranged as the anode in a magnesium energy storage device. The electrode can also comprise an electrically conductive material as described above. During a discharge state, Mg²⁺ ions 107 are extracted from the MgₓBi_{y} nanostructured insertion-material anode into the electrolyte 109. The Mg²⁺ ions pass through the separator 108 to a cathode. The cathode comprises an intercalation material 110 into which Mg²⁺ ions 111 can be inserted. One example of an intercalation material for cathodes includes, but is not limited to, Mo₆S₈.

Referring to FIG. 2, a graph of voltage as a function of capacity compares the performance of magnesium cells utilizing bismuth nanostructured insertion-material anodes (Bi-Nano) or bismuth microparticle anodes (Bi-Micro). The composite anodes were prepared by first mixing Bi nanotubes or Bi microparticles with carbon black and PVDF in NMP to form a uniform slurry. Each type of slurry was then coated onto separate Cu foils, and then dried at 120° C. in a vacuum for 24 hrs. To assemble the cell, one separator, which was soaked in an electrolyte solution comprising Mg(BH₄)₂, LiBH₄, and diglyme, was sandwiched between Mg metal foil and either the Bi-Nano or Bi-Micro composite electrode. The Bi-Nano anode exhibited a capacity that is 1.5 times that of the Bi-Micro anode at the same charge/discharge rate. The result is unexpected and is not merely attributable to the increased porosity or surface area. The use of an anode comprising tin nanoparticles showed poor performance compared to an anode comprising Bi nanoparticles.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. An energy storage device having an electroactive species comprising magnesium, an electrolyte salt comprising magnesium, and an anode comprising bismuth nanostructures having at least one dimension that is less than or equal to 25 nm, wherein at least a portion of the magnesium is reversibly inserted into and extracted from the anode during discharging and charging processes, respectively.

2. The energy storage device of claim 1, wherein the anode comprises a composite having bismuth nanostructures and an electrically conductive material.

3. The energy storage device of claim 2, wherein the electrically conductive material comprises carbon.

4. The energy storage device of claim 1, wherein the bismuth nanostructures comprise bismuth nanotubes.

5. The energy storage device of claim 1, wherein the bismuth nanostructures comprise a structure selected from the group consisting of nanoparticles, nanowires, nanorods, nanoplates, and combinations thereof.

6. The energy storage device of claim 1, wherein the bismuth nanostructures comprise bismuth nanotubes, bismuth nanowires, bismuth nanorods, or combinations thereof having an average diameter less than or equal to 15 nm.

7. The energy storage device of claim 1, wherein the anode is separated from a cathode by a glass fiber separator.

8. The energy storage device of claim 1, having an anode specific capacity greater than 260 mAh/g based on complete anode weight.

9. The energy storage device of claim 1, further having a cathode comprising a transition metal oxide.

10. The energy storage device of claim 1, further having a cathode comprising a transition metal sulfide.

11. The energy storage device of claim 1, further having a cathode comprising a conjugated polymer.

12. An energy storage device having a capacity greater than 260 mAh/g based on complete anode weight, an electroactive species comprising magnesium, an electrolyte comprising a magnesium salt, and an anode comprising bismuth nanotubes having an average diameter less than or equal to 15 nm, wherein magnesium is reversibly inserted into and extracted from the bismuth nanotubes during discharging and charging processes, respectively.

13. A method for preparing an electrode comprising the steps of
configuring an electrochemical cell having an anode comprising magnesium metal, a cathode comprising bismuth nanostructures having at least one dimension that is less than or equal to 25 nm, and an electrolyte solution comprising a magnesium salt; and
electrochemically stripping magnesium from the anode and inserting magnesium into the cathode, thereby yielding an insertion-material electrode comprising MgₓBi_{y}.

14. The method of claim 13, wherein the bismuth nanostructures comprise bismuth nanotubes.

15. The method of claim 13, wherein the bismuth nanostructures comprise a structure selected from the group consisting of nanoparticles, nanowires, nanorods, nanoplates, and combinations thereof.

16. The method of claim 15, wherein the bismuth nanostructures comprise bismuth nanotubes, bismuth nanowires, bismuth nanorods, or combinations thereof having an average diameter less than or equal to 15 nm.

17. The method of claim 13, wherein the electrolyte solution comprises:
an organic solvent selected from the group consisting of diglyme, triglyme, tetraglyme, and combinations thereof;
a first salt substantially dissolved in the organic solvent and comprising a magnesium cation; and
a second salt substantially dissolved in the organic solvent and comprising a magnesium cation or a lithium cation;
the first salt, the second salt, or both comprise a BH₄ anion.

18. The method of claim 13, further comprising the steps of configuring an energy storage device having the insertion-material electrode as a negative electrode during a charged state of the energy storage device.

19. The method of claim 18, further comprising configuring the energy storage device to have a positive electrode comprising Mo₆S₈ during a charged state of the energy storage device.
